(19) United States
(12) Patent Application Publication
(10) Pub. No.: US 2005/0191528 A1
(43) Pub. Date: Sep. 1, 2005

(54) Battery energy storage module

(75) Inventors: Timothy M. Cortes, Dallas, TX (US); Keith C. Schmid, St. Charles, IL (US); Joseph Szymborski, Clemont, FL (US)

Correspondence Address: MORRISON & FOERSTER LLP, 1650 TYSONS BOULEVARD, SUITE 300, MCLEAN, VA, 22102, US

(73) Assignee: Exide Technologies, Lawrenceville, NJ (US)

(21) Appl. No.: 11/013,394

(22) Filed: Dec. 17, 2004

Related U.S. Application Data
(60) Provisional application No. 60/529,757, filed on Dec. 17, 2003.

(51) Int. Cl. H01M 10/44

(52) U.S. Cl. 429/7; 429/50; 320/135

(57) ABSTRACT

Disclosed are energy storage cells and battery systems made therefrom which can provide a regulated, constant voltage to a load independent of the charge state of the cells and other factors, such as cell polarization, which may cause the battery's output voltage to vary. In an illustrative embodiment, the battery system includes a dc-dc converter and a reference voltage circuit. The converter draws power from one or more energy storage cells and upconverts or downcoverts to provide an output voltage that matches the reference voltage.

### FIELD OF THE INVENTION

This application claims the benefit of the priority of provisional application Ser. No. 60/529,757, filed Dec. 17, 2003 which is hereby incorporated by reference in its entirety.

### FIELD OF THE INVENTION

The invention relates to energy storage modules and battery systems that employ energy modules that permit an output voltage to be maintained essentially constant throughout the discharge of the battery, independent from the actual voltages of the electrochemical cells that make up the battery. In another embodiment, energy storage modules according to the present invention may permit the adjustment of the output voltage of a battery system to be compatible with the electrical load of a device that draws power from the battery system.

### BACKGROUND OF THE INVENTION

The voltage of a battery is typically determined by the electrochemical cell system that is used to construct the battery. For instance, a lead-acid cell usually has an electrochemical potential of approximately 2.0 volts and a lead-acid battery comprised of 6 cells connected in series has a voltage of approximately 12 volts. The voltage of the battery is typically the sum of the electrochemical potential of each cell connected in series that to form the battery. Other electrochemical cells have other cell potentials, such as 1.2 volts per cell for a nickel-cadmium electrochemical cell, and 1.5 volts per cell for a carbon-zinc (dry) cell.

Methods for manufacturing batteries having multiple cells present drawbacks due to the polarization that occurs within each cell. To achieve a desired battery voltage one might connect the appropriate number of electrochemical cells in series to reach a desired electrochemical potential for the battery system. For example, to provide a nominal 12-volt battery using lead-acid cells requires that 6 lead-acid electrochemical cells be connected in series (6 cells×2.0 volts per cell=12 volts). The same 12-volt battery could be constructed using 10 nickel-cadmium cells connected in series (10 cells×1.2 volts per cell=12 volts). Because electrochemical cells exhibit polarization (i.e., a shift in their electrochemical potential as current is passed through the cell causing it to be discharged or charged), the battery's voltage will be lower than its nominal value during discharge and higher than the nominal value while it is being charged. This results in a range of voltage over which the battery actually operates.

The inconsistency in voltage caused by polarization may cause problems with the electrical load and circuitry being powered by the battery. Resistive loads such as lamps will become dimmer as the battery discharges and will become brighter while the battery is being charged. Electric motors will change speed as the battery's voltage changes. Certain electronic equipment with sensitive voltage requirements can fail or operate improperly if the voltage powering it varies too greatly. Since many electrical devices operate as fixed power loads, the discharge current required by the device increases as the battery's voltage decreases (the battery's voltage decreases as it is discharged.) This effect requires that wiring and other electrical components be sized for the maximum current expected as the battery discharges and to account for the heating of components that may due to the increased current draw.

Electrical loads typically operate within a defined and limited range of input voltage, and batteries are designed and constructed to provide a certain range of voltages to match the input requirements of the electrical loads they are powering. Since batteries are normally made up of more than one cell, if one of the electrochemical cells in the battery fails for whatever reason, the output voltage of the battery is usually reduced by the electrochemical potential of that cell. For example, if one cell in a 12-volt lead-acid battery made up of 2 volt cells were to fail, the battery's output voltage would be reduced nominally to 10 volts. This may be lower than the operating range for the typical 12-volt electrical system. The result of the cell failure is that the electrical system would also fail to operate with the loss of a single lead-acid electrochemical cell in the battery. In effect, the reliability and availability of the electrical load in this example is only as good as the reliability of a single electrochemical cell in the battery providing power to it.

Another typical type of battery construction is known as the “monoblock” configuration. In this type of construction several electrochemical cells of a given type are housed in a common container and cover assembly and connected either internally or externally in either series, parallel or a series/parallel configuration. Monoblock type batteries usually have nominal voltages of 6 or 12-volts, but they can be of any multiple of the potential of the electrochemical cell that comprises the battery.

Monoblock batteries typically consist of a group of electrochemical cells connected in series to provide a certain overall terminal voltage. The cells are typically housed in a common container with a common cover, and access to individual cells within the monoblock is impractical. Furthermore, the intercell connections putting the cells in series are typically internal to the container. This makes it difficult to repair or replace an individual cell within the monoblock should it fail for any reason whatsoever. The terminal voltage of the monoblock is determined by the potential of the electrochemical cell used and the number of cells connected in series. For example, a 12-volt lead-acid monoblock battery would consist of 6 lead-acid cells, each with a nominal cell voltage of 2 volts, connected in series. The terminal voltage of the monoblock thus can only vary in multiples of the nominal potential of the electrochemical cell used in its construction.

### SUMMARY OF THE INVENTION

In one embodiment, the invention is illustratively characterized as a battery system including at least one energy storage cell in which the output voltage is maintained essentially constant, even if one or more of the electrochemical cells that comprise the battery should fail.

The battery system may include at least one energy storage unit, such as an electrochemical storage cell. Storage cells that may be used in accordance with the invention include lithium-ion polymer cells, alkaline cells, nickel cadmium cells, nickel metal hydride cells, lead acid cells, combinations thereof, and most other types of electrochemical cells of varying chemistries, configurations, and geometries (rolled coil, flat stack, prismatic, monoblock, etc.)

The battery system may also comprise a dc-dc converter unit capable of upregulation and/or downregulation. Such a converter is known in the art as having buck-boost capabilities to allow it to produce an output that bucks (reduces) or boosts(increases) the voltage of of the source. The converter may receive a reference voltage from a reference voltage circuit. The reference voltage may be determined by an external output source fed to the reference voltage circuit via an external source, a switch (such as a dip switch), a software command, or other means. The reference voltage may be stored in a memory or other storage unit within the reference voltage circuit.

The battery system may also include output terminals for connecting a load to the battery, so that the load may draw power from the battery system. The dc-dc converter supplies a voltage across the output terminals that corresponds to a signal sent from the reference voltage circuit to the dc-dc converter, presenting the load with an essentially constant voltage source, regardless of the charge state of the batteries. Further, the voltage may also remain essentially constant even if one or more of the energy storage cells in the battery system fails, when the system comprises more than one such cell.

### BRIEF DESCRIPTION OF THE DRAWING FIGURES

FIG. 1 illustrates an embodiment of a battery system having numerous energy storage cells, a dc-dc converter, and a reference voltage circuit.

### DETAILED DESCRIPTION OF THE INVENTION

In one embodiment, the invention relates to a constant output voltage battery energy storage module. The proposed energy storage module consists of several electrochemical cells connected to a dc-to-dc converter with buck-boost capabilities (i.e., up/down regulation). The electrochemical cell is preferably a lithium ion polymer type, but other type electrochemical cells, such as lead-acid or nickel-cadmium could be utilized as well.

Certain dc-to-dc converters have the capability to buck and boost their output voltage by some multiple of the nominal applied voltage. If the dc-to-dc converter had a buck-boost factor of two times for example, its output would be such that if the input voltage to the dc-to-dc converter were 12 volts, its buck voltage output could be as low as 6 volts and its boost voltage as high as 24 volts, i.e., the voltage could be upregulated to 24 volts or downregulated to 6 voltages. In the proposed invention, the output of the dc-to-dc converter is set to a fixed voltage which is independent of the input voltage to the dc-to-dc converter. Thus the dc-to-dc converter would draw power from the electrochemical cells and output it to the electrical load at a constant voltage.

As the battery discharges and its internal electrochemical potential decreases, the dc-to-dc converter would draw additional power in order to maintain its constant voltage output. The output voltage of the dc-to-dc converter could be established by a reference voltage, a selectable dip switch, other electromechanical device, or by a software digital command.

As described above, one or more electrochemical cells would be connected through appropriate electronic circuitry to a dc-to-dc converter. The dc-to-dc converter would have buck-boost capabilities and the individual or collective voltage of the attached electrochemical cells need not necessarily match the desired output voltage. The output of the dc-to-dc converter would then be set either by imprinting with a reference voltage, a selectable dip switch or other electromechanical device, or by a digital software command. In operation, the dc-to-dc converter would draw power from the electrochemical cells and adjust its output voltage to the selected output voltage using its buck-boost capabilities. The dc-to-dc converter would maintain its output voltage at a constant value by drawing more or less power from the electrochemical cells to accommodate for either changes in the load being powered or the potential of the electrochemical cells providing power to the input of the dc-to-dc converter.

The proposed invention would allow an energy storage module and/or battery to provide dc power of the exact voltage required by the application for optimum operational performance. Using just a battery, the voltage supplied to the load will vary depending on the discharge rate and the battery's charge state. As a result, the load device will either draw additional current from the battery or change its operating performance to correspond with the voltage change of the battery. This could cause the device to operate improperly, overheat and potentially fail. With the proposed invention the voltage supplied to the electrical load device can be maintained constant, eliminating all of the disadvantages cited above.

The number of electrochemical cells supplying the input voltage to the dc-to-dc converter can vary. Various types of dc-to-dc converters that have greater or smaller output ranges compared to its input voltage could be used. Other types of electrochemical cells (lithium ion polymer, lead-acid, nickel-cadmium, etc.) could be used. The output voltage could be defined by a dip switch, other analog voltage signal or digital software command.

Another embodiment of the invention relates to a battery energy storage module with capabilities for providing an architecture with high availability characteristics. For example, an energy storage module utilizing the proposed invention could consist of 4 lithium ion polymer cells each with a nominal cell potential of 4 volts connected through the appropriate circuitry to a dc-to-dc converter with an output set to 13.5 volts. When all of the cells are operative, the dc-to-dc converter would utilize its “buck” capabilities to reduce the voltage of the electrochemical cells from a nominal value of 16 volts to the desired 13.5 volt output. If one of the electrochemical cells were to fail, the dc-to-dc converter would then utilize its “boost” capabilities to raise the voltage of the electrochemical cells from a nominal value of 12 volts to the desired 13.5 volt output. To achieve this the dc-to-dc converter would draw additional power from the remaining electrochemical cells to maintain its output voltage. Although the total energy (volts times amps) would be reduced in proportion to the percentage loss of the failed cell relative to the total number of cells in the battery, the battery's output voltage would be maintained allowing the electrical load being powered to continue to operate. This would prevent the availability of the electrical equipment being powered from dropping to zero.

The proposed invention would allow an energy storage module and/or battery to continue to provide dc-power of the exact voltage required by the application for optimum operational performance even after the loss of one or more of the electrochemical cells that comprise the battery has failed. This would increase the availability of the electrical equipment being powered.

The number of electrochemical cells supplying the input voltage to the dc-to-dc converter can vary. Various types of dc-to-dc converters that have greater or smaller output ranges compared to its input voltage could be used. Other types of electrochemical cells (lithium ion polymer, lead-acid, nickel-cadmium, etc.) could be used. The output voltage could be defined by a dip switch, other analog voltage signal or digital software command, providing a dc energy storage device using electrochemical cells that can supply a constant output voltage even if one or more of the electrochemical cells that comprise the device should fail.

Another embodiment of the invention relates to a monoblock battery construction comprised of energy storage modules. An embodiment of a monoblock battery according to the present invention may consists of one or more energy storage modules, each consisting of several electrochemical cells connected to a dc-to-dc converter with “buck-boost” capabilities. The cells may be housed in a common enclosure consisting of a container and a cover and connected to common external terminals. As with the other types of cells described herein, the electrochemical cell is preferably a lithium ion polymer type, but other type electrochemical cells, such as lead-acid or nickel-cadmium could be utilized as well. Certain dc-to-dc converters have the capability to buck and boost their output voltage by some multiple of the nominal applied voltage. If the dc-to-dc converter had a buck-boost factor of two times for example, its output would be such that if the input voltage to the dc-to-dc converter were 12 volts, its buck voltage output could be as low as 6 volts and its boost voltage as high as 24 volts. In the proposed invention, the output of the dc-to-dc converter of each of the energy storage modules is set to a fixed voltage that is the same for all of the energy storage modules within that monoblock battery, but is independent of the input voltage to that dc-to-dc converter. The outputs of all of the energy storage modules are then connected together to provide the desired overall terminal voltage for the monoblock battery unit. The output voltage of each dc-to-dc converter could be established by a reference voltage, a selectable dip switch or other electromechanical device, or by a software digital command.

As described above, the monoblock battery might consist of one or more energy storage units housed in a common enclosure consisting of a container and cover fitted with terminals that provide a connection point of the overall voltage of the monoblock. Each of the energy storage units would consist of several electrochemical cells connected through appropriate circuitry to a dc-to-dc converter. The electrochemical cell is preferably a lithium ion polymer type, but other electrochemical cells, such as lead-acid or nickel-cadmium could be utilized as well. The dc-to-dc converter would have the capability to buck and to boost its output voltage by some multiple of the nominal applied voltage. The output of the dc-to-dc converter of each of the energy storage units would be set to the same value and consistent with the desired overall terminal voltage of the monoblock. The outputs from each of the energy storage units would be connected in parallel to the terminal connection of the monoblock. The overall capacity of the monoblock could thus be increased by installing additional energy storage units in parallel and connected to the monoblock terminal connections. Each of the energy storage units would output power through the dc-to-dc converter at a constant output voltage. Logic internal to each of the energy storage units would terminate charge and discharge to that individual energy storage unit. Each energy storage unit essentially would operate independent from any other energy storage unit in the monoblock battery.

The monoblock battery could be adapted with additional logic to communicate both with the individual energy storage units as well as to other external devices. The output voltage of the energy storage unit could be established by application of a reference voltage, a switch or other electrical signal, or a digital software command. For example, a monoblock battery consisting of energy storage units that are comprised of 6 lithium ion polymer cells and a dc-to-dc converter with a buck-boost factor of two could provide overall terminal voltages ranging from 12 volts to 48 volts. Four monoblock batteries each programmed to an output of 48 volts could then be connected in parallel to power a typical telephone switch. The same monoblock could be programmed for an output voltage of 12 volts, and four monoblocks could then be connected in series to provide 48 volts to the same telephone switch. If the equipment operated more efficiently at 42 volts, the output voltage of each of the monoblock batteries could be adjusted to 42 volts and the monoblock operated either alone or in parallel with other monoblock batteries.

The proposed invention would provide a monoblock battery configuration with an output voltage that could be adjusted over some defined range. For example, a monoblock constructed using energy storage units containing 6 lithium ion polymer electrochemical cells and a dc-to-dc converter with a buck-boost factor of two could be utilized to provide battery monoblocks with terminal voltages from 12 to 48 volts. Essentially any output voltage within that range would be possible. The monoblocks could then be used alone or in parallel or series to power an electrical load. Since the output voltage of each of the energy storage units would be individually controlled, the parallel arrangement of energy storage units in the monoblock container would provide true redundancy. Failure of a single electrochemical cell in the overall system would have no effect on the output voltage of the monoblock and only marginal effect on the monoblocks overall energy delivery capacity. Capacity of the monoblock could be increased by increasing the number of energy storage units housed within the monoblock container. With a very few monoblock containers it would be possible to accommodate a wide range of battery voltage and capacity requirements. Battery monoblocks could be quickly built to order for capacity and voltage on an individual basis allowing greater flexibility in satisfying customer application needs with greater simplicity in manufacturing and inventory.

The number of electrochemical cells supplying the input voltage to the dc-to-dc converter at the energy storage unit level can vary. Various types of dc-to-dc converters that have greater or smaller output ranges compared to its input voltage could be used. Overall monoblock terminal voltage could be greater or less than that described in this record. Other types of electrochemical cells (lithium ion polymer, lead-acid, nickel-cadmium, etc.) could be used. The output voltage could be defined by a dip switch, other analog voltage signal or digital software command. The monoblock housing could also be another structure in which to mount and house the energy storage units—for example a relay rack panel, a card cage, etc.

According to this embodiment of the invention, therefore, it is possible to provide a monoblock battery construction that supplies voltage over a range wider than that defined by the potential of the electrochemical cells used and the number of cells connected in series. The invention permits for a monoblock battery construction in which the output is adjusted to a fixed value that remains essentially constant over the discharge of the battery. Additionally, the monoblock battery construction can have a capacity that may be varied by the addition of energy storage modules.

Another embodiment of the invention relates to a self configuring battery energy storage module. A purpose of this invention is to provide an energy storage module and a subsequent battery system in which the output voltage is imprinted onto the battery and defined by an external source causing the energy storage module or battery to “learn” what its output voltage is supposed to be.

The proposed energy storage module consists of several electrochemical cells connected to a dc-to-dc converter with “buck-boost” capabilities. The electrochemical cell is preferably a lithium ion polymer type, but other type electrochemical cells, such as lead-acid or nickel-cadmium could be utilized as well. Certain dc-to-dc converters have the capability to buck and boost their output voltage by some multiple of the nominal applied voltage. If the dc-to-dc converter had a buck-boost factor of two times, for example, its output would be such that if the input voltage to the dc-to-dc converter were 12 volts, its buck voltage output could be as low as 6 volts and its boost voltage as high as 24 volts. The buck-boost factor of the dc-to-dc converter described in this invention is two; however the buck-boost factor could be of any value. This embodiment of the invention may, for example, use three lithium ion polymer cells each with a nominal electrochemical cell potential of 4 volts connected through the appropriate control circuitry in series to provide a nominal 12 volt input to the dc-to-dc converter. Thus the output of the dc-to-dc converter with a buck-boost factor of two could range from as low as 6 volts to as high as 24 volts. The described embodiment of the invention allows the output voltage of the dc-to-dc converter to be “defined” by applying a reference voltage equal to the desired output voltage of the energy storage module to the dc-to-dc converter. This allows the battery to “learn” to match its subsequent output to the reference voltage applied, thereby supplying a load with the load's optimum or otherwise desirable voltage. Thus for example, if the applied voltage (load voltage) is 13.5 volts, the energy storage module's dc-to-dc converter could upregulate the nominal 12-volt input provided by the three lithium ion polymer electrochemical cells to a constant output voltage of 13.5 volts. In addition to an applied reference voltage, a switch or other electrical signal or a software command could be used to “teach” the dc-to-dc converter what its output voltage should be.

As described above. Individual energy storage modules and batteries constructed of multiple energy storage modules could “learn” to provide an exact output voltage consistent with the voltage requirements for the equipment being powered. Energy storage modules and/or batteries could be “taught” their desired output voltage before being shipped to the customer or the energy storage module and/or battery could be taught its desired output voltage on-site by connecting the battery to a power source of the correct load voltage and allowing the energy storage module to learn its desired output voltage. Certain devices may be equipped with a reference voltage output that could be connected to the battery, to facilitate imprinting the optimum load onto a memory or other storage means within the battery. Similarly, the energy storage module or battery's output voltage can be switch selectable or established by software command.

The proposed invention would allow an energy storage module and/or battery to provide dc-power of the exact voltage required by the application for optimum operational performance. It would allow a single energy storage module to provide a wide range of output voltage that is not narrowly restricted by the number of electrochemical cells and their potential in the device. It would allow a single manufacturing model to be used for a wide range of voltage applications and because it would be possible to teach the energy storage module what its output voltage is supposed to be just prior to shipment to a customer, minimize the amount of inventory required to satisfy a wide range of applications. Such an energy storage module with three lithium ion polymer cells providing a 12-volt input to the dc-to-dc converter described in the example in this disclosure could be used for low voltage computer electronics applications (5-9 volts), automotive electronics applications (12-14 volts) and telecommunications electronics applications (20-24 volts).

The number of electrochemical cells supplying the input voltage to the dc-to-dc converter can vary. For example, 6 lithium ion polymer cells connected through the appropriate electronic control circuitry could provide a nominal 24-volt input to the dc-to-dc inverter resulting in an output capability ranging from 12 volts to 48 volts. Other types of dc-to-dc converters could have greater or smaller output ranges compared to its input voltage. Other types of electrochemical cells (other than lithium ion polymer) could be used. The output voltage could be defined by a dip switch, other analog voltage signal or digital software command.

Another embodiment of the invention relates to a battery energy storage module with self testing and diagnostics capabilities. Batteries are often used as electrochemical energy storage devices to provide dc power to various electrical loads. An important characteristic of the battery relative to the electrical load it is powering is the voltage of the battery. Another important parameter of the battery's state is its capacity measured either as ampere-hours or watt-hours of total energy delivered to the load. Batteries tend to lose their abilities to maintain capacity and voltage as the battery ages due to deterioration of the battery's active materials and/or other internal changes that effect the resistance of the battery or its ability to deliver its stored energy. In the past the most reliable method to determine a battery's ability to support the electrical load it is powering was to perform a load test on the battery.

When a load test is performed on a battery in an application installation, it may be required to remove the battery from the electrical load it is powering, connect the battery to an external load bank to discharge the battery, and possibly even provide an alternate back-up system for the electrical load during the test discharge. This presents several logistics problems and requires additional manpower and equipment resources to complete. In addition, the availability of the electrical load powered by the battery being tested may be compromised.

The present invention overcomes these problems by providing an energy storage module and/or a battery system employing such an energy storage module, which is capable of performing an internal self-diagnostics test discharge while maintaining its availability to the electrical load it is powering.

The energy storage module illustratively described in this embodiment of the invention may include one or more electrochemical cells connected to a dc-to-dc converter with “buck-boost” capabilities. The electrochemical cell is preferably a lithium ion polymer type, but other type electrochemical cells, such as lead-acid or nickel-cadmium could be utilized as well. Certain dc-to-dc converters have the capability to buck and boost their output voltage by some multiple of the nominal applied voltage. If the dc-to-dc converter had a buck-boost factor of two times for example, its output would be such that if the input voltage to the dc-to-dc converter were 12 volts, its buck voltage output could be as low as 6 volts and its boost voltage as high as 24 volts. In the proposed invention, the output of the dc-to-dc converter is set to a fixed voltage that is independent of the input voltage to the dc-to-dc converter. In addition, the device could contain certain electronic logic circuits that could discharge one of the electrochemical cells that comprise the energy storage module or battery, using the energy drawn from the discharging cell to charge the remaining electrochemical cells or to provide energy to the electrical load connected to the output of the dc-to-dc converter. The dc-to-dc converter would maintain its output at a constant voltage even while one of the electrochemical cells in this configuration was being discharged. The output voltage of the dc-to-dc converter could be established by a reference voltage, a selectable dip switch or other electromechanical device, or by a software digital command.

As described above, several electrochemical cells would be connected through appropriate electronic circuitry to a dc-to-dc converter. The dc-to-dc converter would have buck-boost capabilities and the individual or collective voltage of the attached electrochemical cells need not necessarily match the desired output voltage. The output of the dc-to-dc converter would then be set either by imprinting with a reference voltage, a selectable dip switch or other electromechanical device, or by a digital software command. In addition, the electronics would contain the appropriate logic to allow one of the electrochemical cells that comprise the battery energy storage module to be discharged using the energy removed from that electrochemical cell to charge the remaining cells in the module and/or to power an electrical load connected to the output of the dc-to-dc converter.

For example, an “energy storage module” utilizing the proposed invention could consist of 4 lithium ion polymer cells each with a nominal cell potential of 4 volts connected through the appropriate circuitry to a dc-to-dc converter with an output set to 13.5 volts. When all of the cells are operative, the dc-to-dc converter would utilize its “buck” capabilities to reduce the voltage of the electrochemical cells from a nominal value of 16 volts to the desired 13.5 volt output. On command, either from the internal logic or by signal from an external source, one of the cells would be discharged with the energy being used to charge the remaining cells or to power an external electrical load. As the voltage of the cell being discharged decreases, the dc-to-dc converter would increase the amount of energy being drawn from the other cells in the battery module and use its boost capabilities to maintain a constant output voltage. The module's logic would then determine the available capacity of the cell discharged and determine if it is within an acceptable range. If the capacity of the cell is less than acceptable, the internal logic would send a signal indicating its reduction in available capacity. The invention would allow an energy storage module and/or battery to continue to provide dc-power of the exact voltage required by the application for optimum operational performance even while one of the cells in the module is being capacity discharge tested. The discharge capabilities of the cell tested would be compared and an indication of the cell and module capacity provided. This would be accomplished without requiring the module to be removed from the electrical load that it is powering.

The number of electrochemical cells supplying the input voltage to the dc-to-dc converter can vary. Various types of dc-to-dc converters that have greater or smaller output ranges compared to the input voltage could be used. Other types of electrochemical cells (lithium ion polymer, lead-acid, nickel-cadmium, etc.) could be used. The output voltage could be defined by a dip switch, other analog voltage signal or digital software command. The logic to commence the discharge of a cell within the module could be internal to the module or provided by an external source.

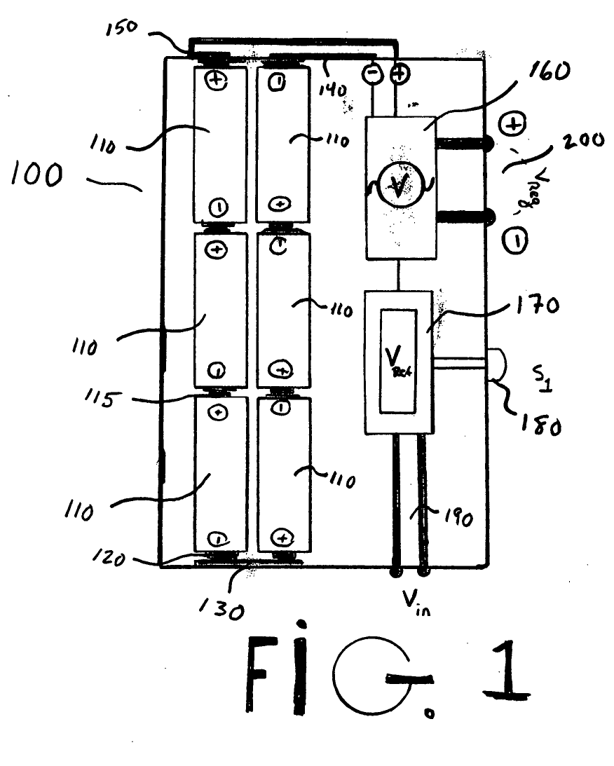

As shown illustratively in FIG. 1, the battery system 100 of the present invention may include numerous energy storage cells 110. FIG. 1 shows 6 energy storage cells connected in series by arranging the cells such that the negative current collector tab 120 of each cell is in contact with the positive collector tab 115 of another cell, with the exception of the cells from which power is drawn from the cells to a dc-dc converter 160 via positive collector circuit 150 and negative collector circuit 140. Since the cells are not arranged in a “straight line” configuration, banks of cells may be employed and connected via collector circuits such as that shown as connector 130.

The dc-dc converter 160 may include a buck-boost capability, allowing it to draw current from the energy storage cells 110 and output a desired voltage via terminals 200. The reference voltage may be supplied by control circuit 170 which may include a memory for storing a reference voltage supplied from an external source 190, a switch 180, or other means.

1. A battery system, comprising:
at least one energy storage unit;
a dc-dc converter unit capable of upregulation and/or downregulation;
a reference voltage circuit; and
output terminals,
wherein the dc-dc converter supplies a voltage across the output terminals that corresponds to a signal sent from the reference voltage circuit to the dc-dc converter.

2. The battery system of claim 1, wherein the reference voltage circuit comprises a switch, a reference voltage signal, a software instruction, or an external load.

3. The battery system of claim 1, wherein the energy storage unit is selected from a lithium-ion storage cell, a cadmium cell, an alkaline cell, a lead-acid cell, and a nickel metal hydride cell.

4. The battery system of claim 1 comprising more than one energy storage cell.

5. The battery system of claim 4 wherein multiple energy storage cells are arranged in a series configuration.

6. The battery system of claim 4 wherein multiple energy storage cells are arranged in a parallel configuration.

7. The battery system of claim 4 wherein multiple energy storage cells are arranged in a series/parallel configuration.

8. The battery system of claim 1, wherein the reference voltage circuit comprises a storage unit for storing a reference voltage.

9. The battery system of claim 8 wherein the reference voltage is supplied by an external source.

10. A method for supplying voltage to a load, comprising:
setting a reference voltage;
drawing power from one or more energy storage cells;
upregulating or downregulating the voltage of the power drawn from the energy storage cells to correspond to the reference voltage; and
supplying the voltage to a load via output terminals.

11. The method of claim 10 wherein the energy storage cells comprise lithium-ion cells, nickel cadmium cells, lead acid cells, nickel metal hydride cells, alkaline cells, and combinations thereof.

12. The method of claim 10 comprising receiving an external reference voltage from an external source and setting the reference voltage to match the external reference voltage.

13. The method of claim 10 comprising setting the reference voltage via a software command.

14. The method of claim 10 comprising setting the reference voltage using a switch.

15. The method of claim 12 comprising imprinting the external reference voltage into a storage unit and setting the reference voltage to correspond to the external reference voltage imprinted on the storage unit.

16. A method for supplying voltage to a load, comprising:
setting a reference voltage;
drawing power from more than one energy storage cell;
upregulating or downregulating the voltage of the power drawn from the energy storage cells to correspond to the reference voltage;
supplying the voltage to a load via output terminals; and
discharge testing at least one of the energy storage cells while supplying the voltage.
